(19) United States
(12) Patent Application Publication
(10) Pub. No.: US 2015/0315934 A1
(43) Pub. Date: Nov. 5, 2015

(54) DEVICE FOR OVERCOMING PLAY

(71) Applicant: SIEMENS AKTIENGESELLSCHAFT, München (DE)

(72) Inventors: Marcel Flock, Essen (DE); Martin Ruhe, Schermbeck (DE); Marc ter Beek, Bocholt (DE)

(73) Assignee: SIEMENS AKTIENGESELLSCHAFT, Munich (DE)

(21) Appl. No.: 14/427,878

(22) PCT Filed: Sep. 17, 2013
(86) PCT No.: PCT/EP2013/069212

§ 371 Date: Mar. 12, 2015

(30) Foreign Application Priority Data
Sep. 19, 2012 (EP) 12185046.5

(51) Int. Cl. F01D 25/28; F16C 35/00

(52) U.S. Cl. CPC F01D 25/28; F16C 35/00; F05D 2220/30

(57) ABSTRACT

A device for overcoming play between a first component and a second component is provided. A first wedge is arranged so as to be movable relative to a second wedge in such a manner that, via a spring force, a tensioning device exerts a frictionally engaging force against the second component.

### CROSS REFERENCE TO RELATED APPLICATIONS

This application is the U.S. National Stage of International Application No. PCT/EP2013/069212 filed Sep. 17, 2013, and claims the benefit thereof. The International Application claims the benefit of European Application No. EP12185046 filed Sep. 19, 2012. All of the applications are incorporated by reference herein in their entirety.

### FIELD OF INVENTION

The invention relates to a device for overcoming play between a first component and a second component, wherein the device comprises a first wedge and a second wedge which are formed such that they can be displaced against one another.

### BACKGROUND OF INVENTION

Large turbomachines, such as steam turbines, must be attached to and mounted on comparatively massive foundations. In general, the axial and radial position of turbine bearings is established by means of dimensionally finished bypass wedges (feather keys) with respect to the bearing housing or with respect to a foundation. Such finished bypass wedges are often made to measure such that, in the assembled state, in which the steam turbine and the foundation are not yet at operating temperature, there is no play between the bypass wedges and the bearing body or bearing housing. In this assembled state, the bypass wedges are fitted without play. However, it can happen that, while the steam turbine is in operation, the operating temperatures give rise to play between the bearing and the bypass wedge, which is caused by thermal expansion between the bearing and the bearing housing. Play arising in this manner is reversible, whereas wear of the bearing faces can lead to irreversible play. The problem in this context is that the increased play can lead to increased wear or, in a worse case, that the dynamic running behavior of the turboset is negatively affected.

Up to now, the bypass wedges have been introduced between the bearing faces with no play or with little play. Re-alignment or adjustment or dynamic matching of the plays in the operating state has not hitherto been carried out.

U.S. Pat. No. 2,524,961 discloses a wedge device.

### SUMMARY OF INVENTION

The invention is intended to provide a remedy here.

An object of the invention is to develop a device for overcoming play between a first component and a second component, which device can be re-adjusted.

This object is achieved with a device for overcoming play as claimed.

A feature of the invention is that play can be canceled out during operation, which is made possible by the force element. In the installed state, the device is incorporated without play. During operation, play to be avoided between the device and the second component is automatically minimized since the force element comprises a tensioning device by means of which a force is exerted permanently on the second component.

Advantageous developments are indicated in the subclaims.

An advantageous measure for improving the invention is that a spring stack, which is prestressed in the operating state, permanently exerts a force on the first wedge and on the second wedge. A permanently-acting force is thereby exerted on a bearing and a bearing housing. In addition to the form-fit, which results from the play-free integration of the first and second wedges, this spring force serves to fix the bearing. In the event that, in the operating state, the gap between the bearing and the bearing housing is widened and thereby the form-fit no longer exists, the spring force remains as a positioning force. The essential advantage is that an indifferent position of the bearing in the bearing housing is thereby avoided.

An advantage resides in the fact that, by virtue of the device according to the invention, it is possible to introduce, into an existing installation, an axial or radial prestress with a re-adjustment function in order to fix radial or axial bearings, without this requiring mechanical reworking on the installation, e.g. on the bearing housing.

Furthermore, it is brought about according to aspects of the invention that, by virtue of the spring force, an additional force-fit is made possible in the first wedge and in the second wedge, by means of which force-fit the bearing is fixed in the bearing housing. If the gap is widened, the spring force serves to maintain the force-fit, in that the first wedge and the second wedge are re-adjusted. The force-fit thus remains.

The device is designed as a compact solution and can therefore advantageously be used during servicing. It is thus possible for the device to be used also in existing installations without further mechanical processing on the bearing or on the bearing housing.

It is also advantageously possible to easily remove the device.

The invention will now be explained in more detail with reference to an exemplary embodiment.

### BRIEF DESCRIPTION OF THE DRAWINGS

In the figures:

FIG. 1 shows a first cross section view of the device,

FIG. 2 shows a second cross section view of the device,

FIG. 3 shows a third cross section view of the device.

### DETAILED DESCRIPTION OF INVENTION

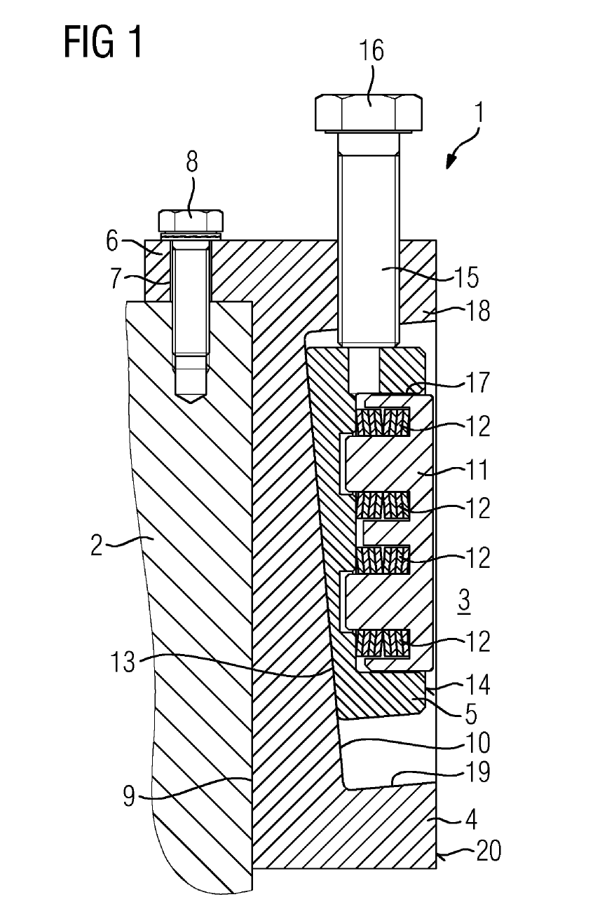

FIG. 1 shows a device 1 for overcoming play between a first component 2 and a second component 3 which is not shown in more detail. The device 1 comprises a first wedge 4 and a second wedge 5. The first wedge 4 has a projection 6. This projection 6 has a bore 7 through which a screw 8 is screwed into the first component 2. The first wedge 4 is thus connected in a force-fitting manner to the first component 2. The first wedge 4 has a front face 9 which is designed for bearing against the first component 2. The first wedge 4 also has a first sliding face 10 which is designed at an angle to the first front face 9 and forms a wedge. The first wedge 4 and the second wedge 5 are arranged such that they can be displaced against one another. A tensioning device 11 is arranged in the second wedge 5. Furthermore, a force element 12 is provided, by means of which the tensioning device 11 can exert a force on the second component 3.

The second wedge 5 has a second sliding face 13 which is designed for bearing against the first sliding face 10. Furthermore, the second wedge 5 has a sliding face 14 which is designed as a sliding bearing face on the second component 3.

A displacement of the second wedge 5 with respect to the first wedge 4 causes the second wedge to move in the direction of the second component 3. This movement is made possible by means of a further bore 15, through which a further screw 16 is arranged, which screw engages in the second wedge 5. Turning the screw 16 causes the second wedge 5 to move with respect to the first wedge 4.

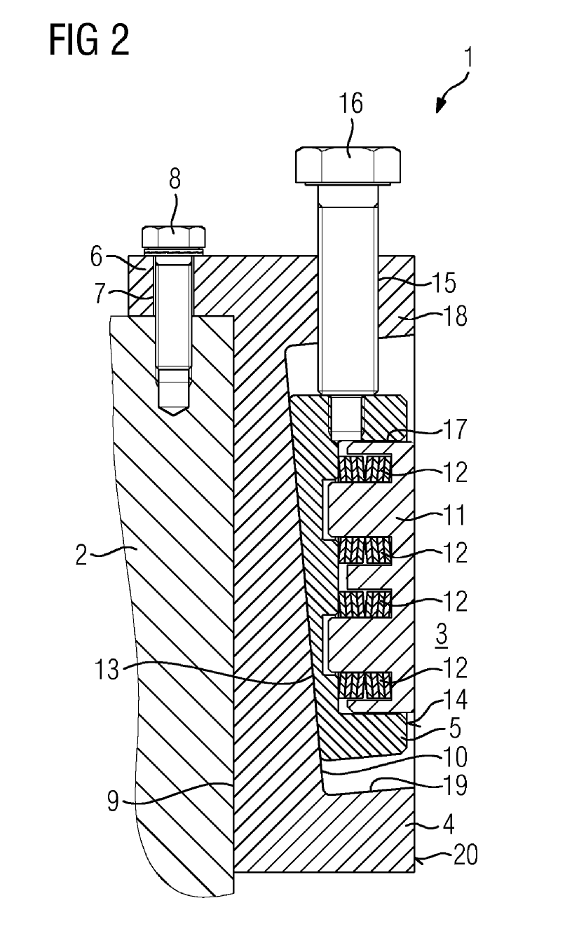

A groove 17 is arranged on the sliding face 14 in the second wedge 5, which groove is designed to receive the tensioning device 11. The force element 12 is arranged between the second wedge 5 and the tensioning device 11. The force element 12 comprises Belleville washers which exert a spring force between the second wedge 5 and the tensioning device 11. FIG. 2 shows, in comparison with FIG. 1, a further displacement of the second wedge 5 with respect to the first wedge 4. It can be seen that the separation of the second wedge 5 and the tensioning device 11 from the second component 3 has decreased.

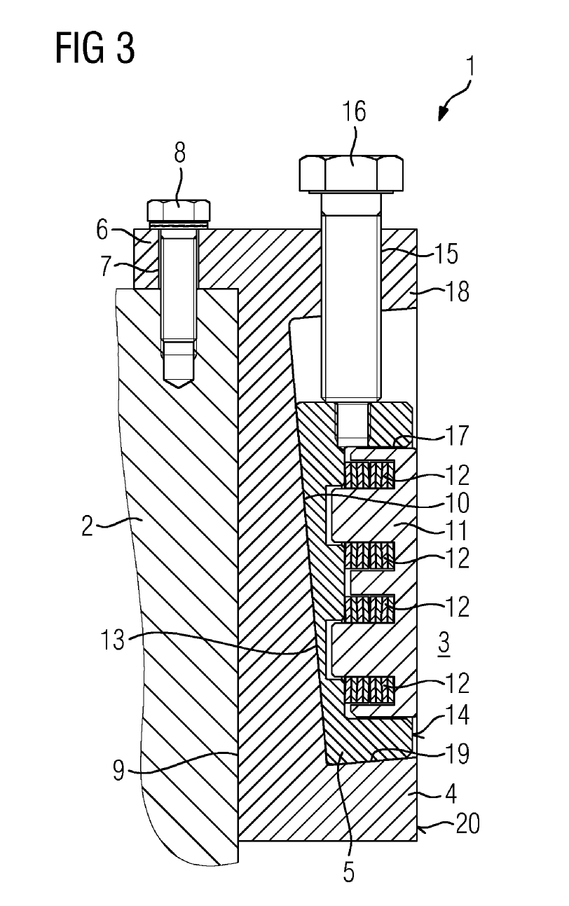

Finally, FIG. 3 shows a further movement of the second wedge 5 with respect to the first wedge 4, wherein the separation of the second wedge 5 and the tensioning device 11 from the second component 3 has decreased once again. A force-fitting effect with respect to the second component 3 is made possible by the force element 12 designed as springs. The device 1 remains in this state. If the separation between the first component 2 and the second component 3 were to increase during operation, this play would be overcome as a consequence of the spring force of the force element 12 designed as Belleville washers.

If the spring force of the force element 12 were to fail or be insufficient, or if the springs or the sliding faces were to fail, the second wedge 5 alone takes on the function and must be designed such that an upper endstop 18 and a lower endstop 19 do not lead to undesirable fault events.

1. A device for overcoming play between a first component and a second component, wherein the device comprises
a first wedge and a second wedge which are formed such that they can be displaced against one another,
a tensioning device arranged in the second wedge, and
a force element, by means of which the tensioning device can exert a force on the second component,
wherein the sliding face in the second wedge has a groove for receiving the tensioning device.

2. The device as claimed in claim 1,
wherein the first wedge has a first front face for bearing against the first component and a first sliding face for bearing against the second wedge,
wherein the second wedge has a second sliding face for bearing against the first sliding face and a sliding face for bearing against the second component.

3. The device as claimed in claim 1,
wherein the force element is arranged between the second wedge and the tensioning device.

4. The device as claimed in claim 1,
wherein the force element comprises elastic springs.

5. The device as claimed in claim 1,
wherein the first wedge has an attachment device for attaching the first wedge in a force-fitting manner to the first component.

6. The device as claimed in claim 1,
wherein the first wedge comprises a displacement device for displacing the second wedge against the first wedge.

7. The device as claimed in claim 1,
wherein the displacement device comprises a screw.
